(19) United States
(12) Patent Application Publication
(10) Pub. No.: US 2023/0151198 A1
(43) Pub. Date: May 18, 2023

(54) Extruder Systems and Processes Thereof

(71) Applicant: Celanese International Corporation, Irving, TX (US)

(72) Inventors: Mallarie D. McCune, Houston, TX (US); Jianya Cheng, Kingwood, TX (US); Ronald DeYoung, Pensacola, FL (US)

(21) Appl. No.: 17/974,591

(22) Filed: Oct. 27, 2022

Related U.S. Application Data
(60) Provisional application No. 63/273,520, filed on Oct. 29, 2021.

(51) Int. Cl. C08L 23/16; C08L 23/10; C08L 23/04

(52) U.S. Cl. CPC C08L 23/16; C08L 23/04; C08L 23/10

(57) ABSTRACT

The present disclosure relates to extruder systems and processes thereof. In at least one embodiment, a method of forming a thermoplastic vulcanizate (TPV) composition includes introducing a thermoplastic polymer to an extruder through a feed throat. The elastomeric polymer is introduced to a melt feeder and an elastomeric polymer melt including the elastomeric polymer is formed. The melt feeder is coupled to the extruder. Elastomeric polymer melt from the melt feeder is introduced to the extruder. The thermoplastic polymer and the elastomeric polymer melt are fed separately to the extruder. The thermoplastic polymer and the elastomeric polymer melt in the extruder are mixed with a plurality of intermeshing screws having a plurality of mixing zones.

### FIELD

The present disclosure relates to extruder systems and processes thereof.

### BACKGROUND

A thermoplastic vulcanizate (TPV) or dynamic vulanized alloy (DVA) product is a chemically crosslinked rubber encapsulated in a thermoplastic phase. The TPV is typically produced by a combination of distributive and dispersitive mixing under a phenolic resin cure catalyst system to yield a homogeneous dispersion of small particle size EPDM rubber in a polypropylene phase.

Automotive equipment manufacturers and suppliers are increasingly using TPV compositions for automotive weather seals instead of EPDM or other thermoset compounds. Some reasons for the increased use of TPV compositions include advantages in processability and recyclability. Lips are a portion of the weather seal structure with highly demanding requirements for elasticity and resiliency. For example, the lip should immediately retract back to its original position upon deflection when touching glass, for example, at temperatures up to about 90° C.

In addition to elasticity, TPV compositions should have a good balance of other mechanical properties such as hardness and tensile strength. Furthermore, extrusion applications like glass run channels demand excellent surface finish for TPV compositions that are free of defects such as edge tear, surface spots, and optical defects. The inferior elastic properties are, in part, associated with the high yield stress of TPV compositions in the melt state, resulting in a poor flow/melt stagnation.

Thus, there is a need to develop TPV compositions with superior balance of elastic properties in combination with mechanical properties as well as superior flow and extruder processability.

References for citing in an Information Disclosure Statement (37 CFR 1.97(h)) include: U.S. Pat. No. U.S. 7,655,728; U.S. Pat. No. 10,077,344; U.S. Pat. No. 8,158,721; U.S. Pat. No. 9,296/885.

### SUMMARY

The present disclosure relates to extruder systems and processes thereof.

In at least one embodiment, a method of forming a thermoplastic vulcanizate (TPV) composition includes introducing a thermoplastic polymer to an extruder through a feed throat. The elastomeric polymer is introduced to a melt feeder and an elastomeric polymer melt including the elastomeric polymer is formed. The melt feeder is coupled to the extruder. Elastomeric polymer melt from the melt feeder is introduced to the extruder. The thermoplastic polymer and the elastomeric polymer melt are fed separately to the extruder. The thermoplastic polymer and the elastomeric polymer melt in the extruder are mixed with a plurality of intermeshing screws having a plurality of mixing zones.

In at least one embodiment, an extruder system includes a first end, a second end, and a plurality of ports disposed along the extruder. A feed throat is coupled to a first port of the plurality of ports, at the first end of the extruder. A melt feeder is coupled to a second port, of the plurality of ports, downstream of the first port. A curative source is coupled to a third port, of the plurality of ports, the third port disposed downstream or upstream of the second port. A melt pump is coupled to the second end of the extruder.

In at least one embodiment, a method includes forming a thermoplastic vulcanizate (TPV) composition. The method includes introducing a thermoplastic polymer to an extruder though a feed throat at a first location. An elastomeric polymer is introduced to a melt feeder and forming an elastomeric polymer melt comprising the elastomeric polymer, the melt feeder coupled to the extruder. The elastomeric polymer melt is introduced from the melt feeder to the extruder at a second location downstream of the first location. The thermoplastic polymer and the elastomeric polymer melt are mixed in the extruder with a plurality of intermeshing screws.

### DETAILED DESCRIPTION

The present disclosure relates to extruder systems, and processes thereof of using the extruder systems to form a TPV product.

A TPV product is a chemically crosslinked rubber encapsulated in a thermopolastic phase. The TPV is produced using a combination of distributive and dispersive mixing under a resin cure catalyst system.

It has been discovered that a TPV composition with enhanced elastic properties, flow, and surface properties can be obtained by processing materials in extruder systems of the present disclosure and using methods provided herein. Surface property improvement includes extrusion surface roughness (ESR) and surface spot improvement. Without being bound by theory, it is believed that the surface property improvements can be attributed to the reaction kinetics produced by the extruder systems and methods described herein which change the dynamics of the phase inversion of the well mixed products. The systems and methods provided herein provide an enhanced homogeneous dispersion of very small vulcanized rubber particles, for example, no larger than about 5 nm in diameter, such as less than about 3 nm in diameter.

For purposes of the present disclosure, when a polymer is referred to as comprising an olefin, the olefin present in the polymer is the polymerized form of the olefin, respectively. Likewise the use of the term polymer is meant to encompass homopolymers and copolymers, where copolymers include any polymer having two or more chemically distinct monomers.

For the purposes of this disclosure, the term “polypropylene” as used herein means polymers containing propylene as monomers, it can be homopolypropylene or copolymer of propylene and α-olefin comonomers.

For the purposes of this disclosure, the term “polyethylene” as used herein means polymers containing ethylene as monomers, it can be homopolyethylene or copolymer of ethylene and α-olefin comonomers.

As used herein, a “composition” can include the components of the composition and/or one or more reaction product(s) of the components.

### Methods of Making TPV Compositions

In some embodiments, methods of forming a thermoplastic vulcanizate (TPV) composition include introducing a thermoplastic polymer to the extruder through a feed throat. An elastomeric polymer is introduced to a melt feeder coupled to the extruder, to form an elastomeric polymer melt. The elastomeric polymer melt from the melt feeder is introduced to the extruder. The thermoplastic polymer and the elastomeric polymer melt are fed separately to the extruder and mixed in the extruder with a plurality of intermeshing screws and within a plurality of mixing zones of the screws/extruder. In some embodiments, the thermoplastic polymer is introduced to the extruder through a feed throat at a first location. The elastomeric polymer melt from the melt feeder is introduced to the extruder at a second location downstream of the first location. The thermoplastic polymer and the elastomeric polymer melt in the extruder are mixed together with a plurality of intermeshing screws. The thermoplastic polymer may be a polypropylene homopolymer, a polyethylene homopolymer, a propylene ethylene copolymer, or combinations thereof.

The plurality of mixing sections includes at least three mixing sections. At least one of the mixing sections has a mixing intensity that is greater relative to another mixing section of the at least three mixing sections. In some embodiments, a second mixing section has a mixing intensity that is greater relative to a mixing intensity of each of a first mixing zone upstream of the second mixing zone, and a third mixing zone downstream of the second mixing zone, of the at least three mixing zones. In some embodiments, a mixing intensity of a mixing zone located at an initial ½ to ¾ length of the extruder is greater than a mixing intensity of mixing zones along other lengths of the extruder. The thermoplastic polymer and the elastomeric polymer melt is mixed in the extruder with a total effective mixing intensity of about 690 to about 830. The thermoplastic polymer and the elastomeric polymer melt is mixed in the extruder with a total dynamic mixing intensity of about 7,000 sec⁻¹ to about 12,000 sec⁻¹. During mixing, an average extruder temperature is about 160° C. to about 320° C.

In these or other embodiments, the amount of thermoplastic polymer within the thermoplastic phase may be about 5 parts per hundred parts by weight of rubber (phr) to about 350 phr, such as about 7 phr to about 100 phr, or about 20 phr to about 150 phr, such as from about 25 phr to about 150 phr, such as from about 50 phr to about 150 phr, such as from about 60 phr to about 100 phr. The thermopolastic phase is introduced to the extruder separately from the rubber, such as the feed throat disposed proximate to the first end of the extruder.

The thermoplastic polymer is introduced at a first location of the extruder and the elastomeric polymer melt is introduced at a second location, the second location is downstream of the first location, and the first and second location are each located at an initial 1/16 to ¼ length of the extruder.

In some embodiments, fillers (such as calcium carbonate, clays, silica, talc, titanium dioxide, a nucleating agent, mica, wood flour, and the like, and blends thereof, as well as inorganic and organic nanoscopic fillers) may be added to the TPV composition in an amount of about 100 phr or less. In some embodiments, the filler is introduced to the extruder with a reaction moderator (e.g., curing moderator) in a powder blend at an amount of about 10 phr or less, such as about 1 phr to about 4 phr, such as about 1.5 phr, or about 2.0 phr. In some embodiments, the curing moderator is a phenolic resin.

A small amount of filler (e.g., of about 100 phr or less), such as clay, is used to dilute and feed the low amounts of curing moderator as the powder blend. The resulting product having small amounts of filler has a surface that is smooth, free or substantially free of edge tears, free or substantially free of die lines, and/or free or substantially free of visible surface gels.

The powder blend is introduced upstream of the second location of the extruder. The power blend can be introduced at the feed throat disposed at the first location of the extruder. In some embodiments, the powder blend is introduced together with the thermoplastic polymer. Typical processes in which the thermoplastic phase and the rubber is introduced together without a melt feeder, a significant amount of filler is needed to aid the process. It has been discovered that using the melt feeder to heat and process the rubber before introducing the rubber to the extruder eliminates the need for high amounts of filler and enhances product quality.

An curing accelerator, such as a curing accelerator mastermatch is introduced to the feed throat in an amount of less than 3 phr, such as about 0.5 phr to about 2.0 phr. The curing accelerator is stannous chloride, zinc oxide, or a combination thereof.

A carbon black material is introduced into the extruder at a location upstream of the second location. The carbon black is introduced to the extruder separately from the rubber. In some embodiments, the carbon black material is a carbon black masterbatch and is introduced to the extruder at the feed throat. The carbon black masterbatch is introduced at about 5 phr to about 30 phr, such as about 10 phr to about 20 phr. An amount of carbon black masterbatch is dependent on the desired product grade.

In some embodiments, the TPV composition includes a curative, such as a phenolic resin curative. The phenolic resin curative is introduced to the extruder downstream of the melt feeder. The curative is introduced through a liquid pump coupled to the extruder at a third location downstream of the second location (e.g., melt feeder location). The third location is located at an initial ⅓ to ⅔ length of the extruder. The curative is introduced in an amount of about 3 phr to about 10 phr.

Process oil is introduced to the extruder at one or more locations, such as at a location upstream of the curative, downstream of the curative, downstream of the melt feeder, downstream of the feed throat, or combination(s) thereof. In some embodiments, the process oil is a paraffinic oil. Process oils may also be referred to a plasticizer or extender such as an oil, such as a mineral oil, a synthetic oil, an ester plasticizer, or combinations thereof. Mineral oils may include aromatic oils, naphthenic oils, paraffinic oils, isoparaffinic oils, synthetic oils, and combinations thereof. In some embodiments, the mineral oils may be treated or untreated. Useful mineral oils can be obtained under the tradename SUNPAR™ (Sun Chemicals). Other oils are available under the tradename PARALUX™ (Chevron), and PARAMOUNT™ (Chevron) such as Paramount™ 6001R (Chevron Phillips). Other oils that may be used include hydrocarbon oils and plasticizers, such as organic esters and synthetic plasticizers. Many additive oils are derived from petroleum fractions, and have particular ASTM designations depending on whether they fall into the class of paraffinic, naphthenic, or aromatic oils. Other types of additive oils include alpha olefinic synthetic oils, such as liquid polybutylene. Additive oils other than petroleum based oils can also be used, such as oils derived from coal tar and pine tar, as well as synthetic oils, e.g., polyolefin materials. Examples of oils include base stocks.

The process oil is introduced to the extruder in an amount of about 25 phr to about 41 phr split between one or more locations of the extruder.

An extrudate is formed from the thermoplastic polymer and the elastomeric polymer melt from the extruder to a twin screw melt pump to form a composition. The composition is removed from the twin screw melt pump and can be used as a feedstock to form final products, such as an automotive product, such as a weather seal. The composition can be molded into test samples and conditioned according certain specifications for testing. The composition (e.g., TPV composition) has an extrusion surface roughness (ESR) of about 25 µin to about 50 µin, as measured based on an ESR procedure described in Chemical Surface Treatments of Natural Rubber And EPDM Thermoplastic Elastomers: Effects on Friction and Adhesion, RUBBER CHEMISTRY AND TECHNOLOGY, Vol. 67, No. 4 (1994), which is incorporated herein by reference.

The weather seal can be formed from the TPV composition using a weather seal extrusion line such as a 2.5 inch 30:1 extruder with a single or dual screw design and a mixer. The TPV composition formed with the extruder system and processes described herein has a head pressure drop of about 40% or less relative to a control composition made from introducing the thermoplastic polymer and elastomeric polymer simultaneously to the extruder. As used herein, “head pressure drop” refers to a die pressure increase during a profile extrusion test. Lower pressure increase is indicative of better processability. The motor amps was about 10% to about 30% relative to the control composition. Without being bound by theory, it is believed that the reduced head pressure drop and amps is attributed to the reduced amount of filler used in the TPV composition of the present disclosure. Thus, it is believed that the TPV composition described herein can be more easily processed into final products relative to conventional TPV compositions.

The TPV composition has about 23 or less surface spots using visual observation of three strips. The strips are prepared in accordance with the ESR procedure. Each of the strips having about 150 linear centimeters of strip surface is inspected for visible spots. The visible spots protruding from the surface are counted. The total number of spots for each strip is counted and the number of spots having an area of about 0.80 mm² (0.001 in²) or larger are counted.

### Extruder Systems

In at least one embodiment, an extruder system includes a first end, a second end, and a plurality of ports disposed along the extruder. A feed throat is coupled to a first port of the plurality of ports, at the first end of the extruder. A melt feeder is coupled to a second port, of the plurality of ports, downstream of the first port. A curative source is coupled to a third port, of the plurality of ports, the third port disposed downstream or upstream of the second port. A melt pump is coupled to the second end of the extruder. A process oil pump is coupled to a fourth port, of the plurality of ports, upstream or downstream of the third port.

The melt feeder, which provides a polymer (e.g., elastomeric polymer) melt to the extruder, reduces or eliminates a need to granulate elastomeric polymer before introducing the elastomeric polymer (e.g., rubber) to the extruder. The process for granulating rubber includes introducing a partitioning filler to prevent granulated rubber re-agglomeration in the ultimate product. The use of a filler is reduced in the processes described herein. In particular, a small amount of filler, such as clay, can be used to mix with the reaction moderator, and feed the low amounts of reaction moderator as a powder blend. The resulting product having small amounts of filler has a surface that is smooth, free or substantially free of edge tears, free or substantially free of die lines, and/or free or substantially free of visible surface gels.

It has been discovered that the melt pump, such as a twin screw melt pump, disposed at the outlet of the extruder eliminates the occurrence of a side lubricant stream flow back into the main stream being extruded in the extruder.

Screws used in the extruder are intermeshing and co-rotating screws.

An extruder of the present disclosure can have any suitable number of ports, number of screws, number of barrels, barrel lengths, arrangements of solid barrels and combination barrels, depending on processing parameters used. One more screws can be blocking screws. Blocking screws can be designed to prevent the cross-over of material from one portion of the extruder to another portion of the extruder. Blocking screws may be static or can be solid and rotating.

Transitioning the extrudate from one flow zone to the next flow zone in an extruder is defined as leaving a conveying zone and entering a mixing zone, or leaving a mixing zone and entering a conveying zone.

The elements of a screw can be classified as one of a conveying element, a kneader, a back flow element, a flow splitter, or a restrictive conveying element. In some embodiments, a screw of the present disclosure comprises one or more conveying element, one or more kneader, one or more back flow element, one or more flow splitter, one or more restrictive conveying element, or combination(s) thereof in any suitable configuration. Conveying elements are fluted screws of various pitches that are designed to move the extrudate forward in the mixing barrel. Kneaders tend to restrict the flow of the extrudate, and the kneaders provide extreme shearing, particle size reduction, and heat generation. Back flow elements are fluted to reverse the flow of the extrudate, and act as restricting or blocking elements. Restrictive conveying elements can be single flight elements with wide crest or those with slotted flighting which kneads the extrudate as it is conveyed forward. Restrictive conveying elements can have low pitched flights or high pitched flights with slots.

The screw elements are described commercially in their design by letter and number designations. The number and letter designations and the screw elements are available from Century Extruders, Traverse City, Mich.

S and SK refer to conveying elements which do some mixing, but are used mainly to push material in the extruder from the melt feeder end to the extruding end. The SK elements are conveying elements with a higher free volume than regular conveying elements, and are used as transition elements between flow zones. SG refers to elements that convey the extruding material while providing substantial mixing.

KB refers to kneading elements. The kneaders do not have a large bias toward moving the extruding material forward, and tend toward filling with material from upstream in the extruder. The kneaders may comprise any number of plates that may have one or more points. For example, a two point kneading plate has a generally parallelogram shape with two points corresponding to the maximum diameter of the plate, and a three point plate has three similar maximum diameter points and three corresponding flat areas with a diameter close to the diameter of the screw shaft. When a back flow conveyer is used in conjunction with a kneader, filling of the flow zone around the kneader is assured, and the increased pressure and shearing caused by the filling has a tendency to dramatically increase the temperature of the extruding material.

Numbers in the screw element designations refer to the pitch of the flutes, the length of the element and the number of plates in the element. Additional letters refer to their orientation left (L) or right (R) and their type. In the description, the letter ‘N’ denotes that the elements are ‘neutral’, and provide no conveying action in either direction.

S060R030, for example, refers to a conveying element (S), having a flute pitch of 060 mm to the right (R), and having a length of 30 mm. Similarly, KBS405R030 refers to a kneader (KBS) having a separation of 45 ° between adjacent plate tips, five plates with a right hand conveying bias, and a length of 30 mm. S040RL040 Igel and KBS905N030 are flow splitting elements that cut the extruding flow into two or more streams, and directs the divided streams left (L) and right (R) back upon themselves. These flow splitting elements cause a crossover between the inner and outer extrudate streams. S030L015 refers to a back flow conveying element having a pitch of 30 mm to the left (L), and a length of 15 mm. The L designation describes the pitch direction of the fluting as tending to push the extruding material back toward the feed throat, sometimes referred to as reverse flow.

The back flow elements, the kneaders and other non-conveying or low conveying elements, cause a build up of pressure in their particular flow zones, until the pressure of feeding material and the pressure caused by the upstream conveying elements overcomes the back pressure, and forces the extruding material through the respective flow zone.

Back flow elements, when they are used, are at the end of a flow or mixing zone. Since the back flow elements create a dam, it is deemed that they define the end of a flow zone. Similarly, since a restrictive conveying element produces high pressure in its flow zone, the end of such an element, where the pressure is released into a forward conveying element, is considered to be the end of a flow zone.

The function of each flow zone can be defined by its shear rate, and the number of shears carried out in the flow zone. The kneaders and flow splitters, for example, are used for melting and increasing the temperature of the extrusion, in addition to the mixing they provide, and are designed to produce a large number of shears. The conveying elements provide some mixing, but are designed mainly to move the extrusion along, and do not produce as many shears as the kneaders. Most of the other mixing elements fall somewhere between the kneaders and the conveying elements in their mixing capability and their shearing capability.

As illustrated in U.S. Pat. No. 4,594,390, shear rate is defined by C×RPM/tip clearance (where the ‘tip clearance’ is the distance between the tip of the screw and the wall of the extruding chamber (e.g., mixing barrel), and C is the circumference of the element. In other words, the shear rate is the tip velocity divided by the tip clearance. The number of shears, therefore, is the ‘shear rate′×‘the length of the particular flow zone’, and the shear rate is directly related to the mixing aggressiveness of a particular screw profile. In processes of the present disclosure, shear rates of 400 sec⁻¹ or greater can be effectively used.

There is substantial shearing between the tips of the screws and the bottom of the grooves of adjacent intermeshing screws, and the prior calculations do not completely describe the mixing process, and for the purposes of the present disclosure, the mixing ability of a particular screw profile may be described in terms of the ‘meshes’ of the screw, and the ‘intermeshes’ of a plurality of intermeshing screws. As used herein, ‘meshes’ refers to the mixing potential of a particular screw element or profile, and ‘intermeshes’ refers to the mixing potential of a plurality of intermeshing screws.

The number of shears created by a specific screw element is dependent on the profile of that element, and the number of shears created between the screw tips and the mixing barrel will be an inherent property of the element profile, and the calculation of the meshes and intermeshes of the screws is a more satisfactory method of determining a screw profile’s processing ability than the methods described in the prior art.

During processing, when the screws are rotating at a specific RPM, the number of intermeshes/sec, or intermeshes sec⁻¹, can be calculated, as a measure of the amount of mixing taking place in the extrudate. The amount of mixing that goes into the processing of a particular extrudate further depends on the feed rate of the materials, the RPM of the extruder screws, the viscosity ratio and temperature of the materials, their surface wetting properties, the surface tension of the particles, and their flow characteristics.

The FCA is the free cross sectional area in cm² that exists between the screw elements, the barrel surface and the core. Material feeding rate into the extruder is specified on the basis of FCA. For example, in a 30 mm ring extruder the FCA as provided by the vendor is 26.2 cm². At 400 RPM and 200 Kg/Hr rate, the material feeding rate=(200 Kg/Hr)/(26.2 cm²)=7.63 Kg/(Hr×cm²) and at 100 RPM and 50 Kg/Hr, the material feeding rate=(50 Kg/Hr)/(26.2 cm²)=1.91 Kg/(Hr×cm²).

In practice, often the rate, screw speed, barrel temperature and other process conditions are optimized to get target product properties at scale-up. For similar quality in scale-up, it may be important to maintain similar residence time, melt temperature, cure and mixing profile along screw axis on different size extruders. In some embodiments, an extrusion is performed at an extruder temperature (e.g., internal temperature of the barrel) of about 26° C. (80° F.) to about 371° C. (700° F.), such as about 65° C. (150° F.) to about 204° C. (400° F.), such as about 82° C. (180° F.) to about 148° C. (300° F.).

The rate for scale-up at same screw speed can be calculated by multiplying the material feeding rate for the known extruder with the FCA for the desired or target extruder and the diameter ratio of the target and the known extruder. This is further illustrated for the example where rate for a 50 mm ring extruder is calculated from the data from the 30 mm size equipment at 400 RPM. Rate₅₀ₘₘ(kg/hr)=(material feeding rate (kg/(hr×cm²)))₃₀ₘₘ×FCA₅₀ₘₘ×(50 mm/30 mm)=7.63 Kg/(hr×cm²)×74.1 Cm²×1.67=944 kg/hr.

The significant parameters that define the mixing imparted by the extruder in the process are related in the following manner: the degree of mixing is a function of the No. of Tips factor, Pitch factor, Length or L/D factor, Restriction factor, Free Cross-Sectional Area (FCA), RPM and Rate.

Independent of the materials used, the meshes per second in a particular flow zone can be found by multiplying the Restriction Factor, times a length factor, times a pitch factor, times a number of tips factor times the number of revolution per second. The number of intermeshes/sec can be found by multiplying the resulting number by the number of screws used in the extrusion.

Screws of the present disclosure may have 450 to 1020 meshes, such as 500 to 900 meshes, such as 700 to 800 meshes. Screws may have about 10 to 23 meshes per L/D, such as about 11 to about 20 meshes, such as aboutabout 11 to 16 meshes per L/D where meshes per L/D is calculated by dividing the meshes for a given screw design with its L/D.

For the purposes of the present disclosure, a flow zone or a mixing zone can be further defined as a set of one or more mixing elements or a set of one or more conveying elements. End point of each zone is defined by the transition from conveying to mixing elements or vice versa. For example, KB60/3/30 followed by K60/3/30 will be one zone. However, KB60/3/30 followed by a 45/45 or any other mixing element, defines a separation between two different zones. Accordingly, if all 0.5 L/D mixing and conveying elements are used, theoretically a screw of 100 L/D can have 200 mixing zones. Those skilled in the art will recognize that larger diameter machines can use screw elements having <0.5 L/D.

In an effort to quantify the mixing properties of a particular screw profile, Restriction Factors have been assigned to each of the elements used in a screw profile, based on a mixing factor determined by the number of plates, shears and contact area (e.g. restrictive conveying elements have a shorter pitch and higher residence times, and the pressure in the zone is increased), and their function (such as reverse flow), and the radial clearance of the tips between the barrel or an adjacent screw element.

Restriction Factors assigned for specific screw elements are given in Table 1.

TABLE 1

| Screw | Restriction Factor |
|---|---|
| FC = Forward Convey (R) | 1 |
| KBFC = Kneading Block (R) | 2 |
| LHKB = Hand Kneading Block | 6/3 |
| LHCE = (L) Convey Element | 50/15 |
| SFF = Low Pitch Single Flight Forward | 4 |
| LHNI = Left Hand Igel | 2.5 |
| SPEF = Special Elongational Flow Element | 2.5 |
| KBNC = Kneading Block Neutral (N) Convey | 3.5 |
| ZME, SME, TME, (R) | 3 |
| ZME, SME, TME, (L) | 4 |
| Elongational Flow Element | 8 |
| SFL = Low Pitch Single Flight, Left hand Convey | 55/20 |

The SFL, LHKB, and LHCE elements are considered to have a higher Restriction Factor (55, 6 and 50 respectively) when placed after mixing elements, and a less restrictive effect when placed after a conveying element (20, 3 and 15 respectively). Higher Restriction Factors are assigned when more than one left-handed element is located next to another left-handed element.

To describe the mixing value of a particular screw profile in absolute terms, it is expedient to describe the screw in terms of its meshes, i.e. the mixing potential of the screw independent of the rate of rotation, L/D, and the number of screws used. By dividing the number of meshes for a screw design with its L/D, a calculation for number of meshes per L/D for that screw design can be obtained.

In some embodiments, screws with up to 23 meshes per L/D, and L/D up to 100 with up to 170 mixing zones can be used. In some embodiments, as little as 3 mixing zones and 10 meshes per L/D can be used. Accordingly, processes can be performed using screws having a L/D of 15-100, with 3-170 mixing zones, and 3-17 meshes per (L/D). In some embodiments, the screws of the present disclosure have an L/D of about 40 to about 50.

Calculations for meshes of individual elements are given in the meshes table (Table 3). In the table, the element is described by type, the pitch factor, the length factor (given in L/D), the number of flights tips on the element, the restriction factor, and the effective element intensity. The restriction factor column shows the mixing potential for the element in meshes.

In the calculations, the pitch factor=screw diameter/pitch, for example, 30 mm/60 mm=0.5. This applies to SG, SK and S elements, but not to KBS, Igel, LH elements or kneading blocks. The length factor applies to all elements.

The number of tips for the element in the table of meshes is the number of flights×the number of elements or disks, which is 1×1=1 for a single flighted element or disk. For double flighted elements, the number of tips is 2×5=10 for a 5 disk double flighted kneading block, 2×5=10 for a double flighted 5 segmented Igel, and 2×6=12 for a six segmented SG element. For triple flighted kneading block with 5 disks, the number of tips is 3×5=15. By following these examples, this calculation can be used for conveying or mixing elements with >3 flights.

TABLE 2

Table of Meshes

| Screw Element | Element Type | Pitch Factor | L/D Factor | No. of Flight Tips | Restriction Factor | Effective Element Intensity |
|---|---|---|---|---|---|---|
| 30/30 | Conveying | 1.77 | 0.57 | 3 | 1 | 3 |
| 45/15 | Conveying | 1.18 | 0.28 | 3 | 1 | 1 |
| 45/15 LH | Mixing | 1.18 | 0.28 | 3 | 50/15 | 50/15 |
| 45/45 | Conveying | 1.18 | 0.85 | 3 | 1 | 3 |
| 60/20 | Conveying | 0.88 | 0.38 | 3 | 1 | 1 |
| 60/30 N-SF | Conveying | 0.88 | 0.57 | 1 | 4 | 2 |
| 60/30 SF-N | Conveying | 0.88 | 0.57 | 1 | 4 | 2 |
| 60/60 | Conveying | 0.88 | 1.13 | 3 | 1 | 3 |
| 80/80 | Conveying | 0.66 | 1.51 | 3 | 1 | 3 |
| 80/80 K | Conveying | 0.66 | 1.51 | 3 | 1 | 3 |
| 90/30 | Conveying | 0.59 | 0.57 | 3 | 1 | 1 |
| 90/30 SK-N | Conveying | 0.59 | 0.57 | 3 | 1 | 1 |
| KB30/5/20 | Mixing | 1 | 0.38 | 15 | 2 | 11 |
| KB30/5/20 LH | Mixing | 1 | 0.38 | 15 | 6/3 | 34/17 |
| KB30/5/45 | Mixing | 1 | 0.85 | 15 | 2 | 26 |
| KB30/5/60 | Mixing | 1 | 1.13 | 15 | 2 | 34 |
| KB60/3/30 | Mixing | 1 | 0.57 | 9 | 3.5 | 18 |
| KB60/3/60 | Mixing | 1 | 1.13 | 9 | 3.5 | 36 |
| ZME 15/30 | Mixing | 3.53 | 0.57 | 1 | 3 | 6 |

The summation of the effective element intensity of each element in the screw profile is the effective element intensity, as shown in the last column of the table of meshes above (Table 2). The total effective mixing intensity of the screw. In some embodiments, a screw of the present disclosure is rotated at a rate of about 100 revolutions per minute (rpm) to about 500 rpm, such as about 200 rpm to about 400 rpm, such as about 275 rpm to about 375 rpm. In some embodiments, a screw of the present disclosure is operated at a total effective mixing intensity of the screw of about 600 to about 900, such as about 700 to about 800, such as about 750 to about 780.

Total mixing intensity is the summation of each element’s mixing intensity in the screw design and the effective element intensity. The total mixing intensity can be determined using Equation 1.

$$\begin{matrix}\begin{matrix}\text{Total Mixing Intensity =} \\ \text{Element Pitch Factor x Element L/D x} \\ \text{No} \text{. of Flight Tips of the Element x}\end{matrix} \\ \text{Element Restriction Factor}\end{matrix}$$

Ultimately, the dynamic mixing intensity of the screw design can be a key assessment that indicates the degree of mixing power. For example, dynamic mixing intensity takes the mixing intensity and multipilies it by the process RPM in units of sec-1 and by a factor of 2 because there is a total of 2 rotating screws in the extrusion process. Dynamic mixing intensity can be determined using Equation 2.

$$\begin{matrix}D y n a m i c M i x i n g I n t e n s i t y = N o . M e s h e s x \\ S c r e w S p e e d x N o . S c r e w s\end{matrix}$$

For example, for a non-limiting example screw in which the twin screw extruder is mixing a TPV at 350 rpm, the dynamic mixing intensity can be 8,903 sec⁻¹. In some embodiments, a screw of the present disclosure is operated at a dynamic mixing intensity of about 6,000 sec⁻¹ to about 10,500 sec⁻¹, such as about 7,000 sec⁻¹ to about 9,500 sec⁻¹, such as about 8,000 sec⁻¹ to about 9,000 sec⁻¹.

The length of the screw can be regarded as having approximately equal mixing sections, such as four equal quartiles. It is shown in Table 3 that the quartile 3 section of the screw profile is the dominant area of mixing intensity regardless of extruder rpm.

The first quartile of a screw is the quartile located proximate to the first end of the screw, e.g., proximate the feed throat of the extruder. In some embodiments, a first quartile of a screw of the present disclosure is operated at a dynamic mixing intensity of about 700 sec⁻¹ to about 1,800 sec⁻¹, such as about 800 sec⁻¹ to about 1,600 sec⁻¹, or about 1,000 sec⁻¹ to about 1,800 sec⁻¹. In some embodiments, a second quartile of a screw of the present disclosure is operated at a dynamic mixing intensity of about 900 sec⁻¹ to about 2,100 sec⁻¹, such as about 1,000 sec⁻¹ to about 1,900 sec⁻¹, or about 1,200 sec⁻¹ to about 2,100 sec⁻¹. In some embodiments, a third quartile of a screw of the present disclosure is operated at a dynamic mixing intensity of about 2,900 sec⁻¹ to about 5,800 sec⁻¹, such as about 3,000 sec⁻¹ to about 5,000 sec⁻¹, or about 3,100 sec⁻¹ to about 5,600 sec⁻¹. In some embodiments, a fourth quartile of a screw of the present disclosure is operated at an dynamic mixing intensity of about 1,000 sec⁻¹ to about 2,000 sec⁻¹, such as about 1,100 sec⁻¹ to about 1,900 sec⁻¹, such as about 1,100 sec⁻¹ to about 1,500 sec⁻¹, alternatively about 1,600 sec⁻¹ to about 1,900 sec⁻¹. Each of the first, second, third and fourth sections (e.g., quartiles) are in sequence with one another from an upstream end to a downstream end of the extruder.

In some embodiments, a screw of the present disclosure is operated at a total effective mixing intensity of about 500 to about 1,100, such as about 600 to about 900, such as about 700 to about 800. In some embodiments, a first quartile of a screw of the present disclosure is operated at a total effective mixing intensity of about 80 to about 160, such as about 100 to about 140, such as about 110 to about 130. In some embodiments, a second quartile of a screw of the present disclosure is operated at a total effective mixing intensity of about 100 to about 200, such as about 110 to about 190, such as about 130 to about 170. In some embodiments, a third quartile of a screw of the present disclosure is operated at a total effective mixing intensity of about 280 to about 460, such as about 290 to about 450, such as about 280 to about 440. In some embodiments, a fourth quartile of a screw of the present disclosure is operated at a total effective mixing intensity of about 80 to about 200, such as about 90 to about 170, such as about 100 to about 160. In some embodiments, a fifth quintile of a screw of the present disclosure is operated at a total effective mixing intensity of about 110 to about 200, such as about 130 to about 170, such as about 145 to about 155. In some embodiments, a substantial amount of curing occurs in the third quartile.

TABLE 3

Sectional Screw Profile Analysis for a non-limiting example screw with extruder operating at 350 rpm

| Screw Section | Total effective Mixing Intensity | Dynamic Mixing Intensity |
|---|---|---|
| Quartile 1 | 117 | 1366 |
| Quartile 2 | 143 | 1661 |
| Quartile 3 | 375 | 4379 |
| Quartile 4 | 128 | 1497 |

Mixing elements such as ZME, TME, SME, and elongational flow elements have meshes of 20, 15, 10, and 35, respectively. Calculations shown can be applied to elements of any diameter, L/D, number of flights or lobes, or number of disks. One skilled in the art will be able to use their own calculations for determining the number of intermeshes used in a particular extrusion. For example, if a screw has 396 meshes, and 6 screws are used at 360 RPM, the number of intermeshes/sec will be 396×6/sec×6=14,256.

In some embodiments, a screw profile may be used where the screw profile having about 15 to about 40 mixing zones, such as about 25 to about 35 mixing zones of which about 60% to 71% are conveying elements, about 20% to 40% are mixing elements (pitched kneaders) and about 2% to 6% are restrictive conveying elements, wherein the screw has a mixing potential of 543 to 850 meshes can be used. The L/D ratio of screw profiles may be from L/D 36 to L/D 60.

In some embodiments, a screw of the present disclosure has a total of 500-850 meshes.

Residence times for the extrudate in an extruder of processes of the present disclosure can be determined empirically by adding color to the feed throat of the extruder after the start of extrusion from the die, and measuring the time occured for a color change to appear at the extrusion die. In some embodiments, a residence time can be 15 to 180 seconds, depending on the materials being processed.

In some embodiments, a processing oil is added in one location or a plurality of locations along the extruder, in order to control the temperature and the consistency of the composition as it is being processed, as well as to control the properties of an extrudate end product.

In some embodiments, specific energy of the ring extruder is about 0.17 to 0.28 Kw /Kg.

In some embodiments, the extruder can be operated at an output capacity of about 10 kilograms per hour (kg/h) to about 6,000 kg/h, such as about 10 kg/h to about 300 kg/h, alternatively about 300 kg/h to about 1,500 kg/h, alternatively about 1,500 kg/h to about 3,000 kg/h, alternatively about 3,000 kg/h to about 6,000 kg/h.

### Melt Feeder

A melt feeder of the present disclosure may be any suitable melt feeder, such as a melt feeder commercially available from the Bonnot Company of Akron, Ohio. An elastomeric polymer can be introduced and heated in the melt feeder to form an elastomeric polymer melt. The melt feeder is coupled to the extruder to introduce the elastomeric polymer melt to the extruder. The polymer melt can include softened feed, melted feed, or combination(s) thereof.

A melt feeder may include a motor coupled with a first end of a gear box. The gear box is coupled at a second end with a first end of a hopper. The hopper includes a plurality of grinders having a plurality of teeth that are configured to grind a solid feed into small particles. Grinders can be operated (e.g., rotated) by the motor and gear box. The hopper is coupled at second end with a first end of an auger barrel. A plurality of heating jackets is disposed about auger barrel and each heating jacket corresponds to a heating zone to provide controlled heating of the small particles from the hopper.

The feed that is fed into the hopper can be any suitable size. For example, the feed can have an average size of about 3 inches or less, such as about 2 inches or less. The small particles formed from the hopper can have a size of about 0.5 inches or less, such as about 0.25 inches or less. The small particles are directed to the interior space of the auger barrel. A screw is rotably positioned within the auger barrel. During use, rotation of the screw draws the feed/particles/melt from the hopper and moves the feed/particles/melt through the barrel during the heat processing of the feed/particles/melt.

The front end of the screw is coupled with (e.g., connected to) the gear box. The gear box is configured to rotate the screw during use. In some embodiments, the screw has a width of about 1 inch to about 10 inches, such as about 2 inches to about 6 inches, such as about 3 inches to about 4 inches. The screw includes a plurality of flights. The spacing between flights of the plurality of flights can vary, e.g., the flight spacing is greater near the front end of the screw and then reduces continuously or at some point along the front portion of the screw.

The heat jackets are configured to heat the feed/particles/melt as they move inside the auger barrel by the rotation of the screw. The heat jackets can have any suitable size or configuration, or there can be any suitable number of heat jackets. The heat jackets can be heated by fluid (e.g., heated oil, steam, etc.) flowing and/or circulating through the heat jackets and/or can be electric heaters. Generally, the heat jackets are configured to heat the feedstock (e.g., polymer) at a temperature of about 60° C. to about 180° C., such as about 80° C. to about 120° C. The heating of the feedstock in the beginning or front portion of the melt feeder causes water in the feed, if any, to vaporize.

The melt feeder is coupled with (e.g., connected to) the extruder at a feeder end to provide the polymer melt to the extruder and commence functionalizing the polymer, e.g., as described above. In some embodiments, the polymer melt is provided to the extruder at a rate of about 40 kg/hr to about 4,000 kg/hr, such as about 1,000 kg/hr to about 3,000 kg/hr.

In some embodiments, the melt feeder is coupled with the extruder (used to functionalize the polymer) at a first portion (e.g., the initial ⅛ to ½ of the length, such as ¼ of the length) of the extruder. For example, the melt feeder can be coupled with the extruder at a location corresponding to flow zones of the screw used in the extruder for functionalizing the polymer. The terms “initial” and “remainder” are used with reference to the direction an extrudate flows through the extruder.

### Melt Pump

A melt pump of the present disclosure, such as melt pump, may be any suitable melt pump, such as a twin screw melt pump, such as a melt pump commercially available from Henschel GmbH of Germany. The melt pump is coupled at a first end with a second end of an extruder and is coupled at a second end with a first end of an extrusion die.

The melt pump can be a multi-screw extruder (e.g., twin screw extruder) having a horizontal screw arrangement where the feed is fed/removed in a top/bottom configuration. The melt pump can have a cylinder housing operated at a temperature using heating cartridges and water cooling. The melt pump can have one or more screws having a diameter of about 60 millimeters (mm) to about 200 mm, such as about 100 mm to about 140 mm. During use, the screw can be rotated at a speed of about 15 min⁻¹ to about 160 min⁻¹, such as about 53 min⁻¹ to about 150 min⁻¹, alternatively about 31 min⁻¹ to about 94 min⁻¹, alternatively about 23 min⁻¹ to about 69 min⁻¹, alternatively about 16 min⁻¹ to about 47 min⁻¹. The screw can be controlled using a motor operated at a power of about 4 kilowatts (kW) to about 140 kW, such as about 4 kW to about 12 kW, alternatively 11 kW to about 36 kW, alternatively 23 kW to about 70 kW, alternatively 45 kW to about 140 kW. The melt pump can be operated at an output torque of about 700 Newton meter (Nm) to about 28,300 Nm, such as about 3,600 Nm to about 9,800 Nm. The melt pump can be operated at an output capacity of about 10 kilograms per hour (kg/h) to about 6,000 kg/h, such as about 10 kg/h to about 300 kg/h, alternatively about 300 kg/h to about 1,500 kg/h, alternatively about 1,500 kg/h to about 3,000 kg/h, alternatively about 3,000 kg/h to about 6,000 kg/h. The melt pump can be operated at a pressure of about 100 bar to about 500 bar, such as 200 bar to about 350 bar.

The melt pump can be designed such that the twin screws rotate at rotation speeds of about 30 rpm to about 300 rpm, such as about 50 rpm to about 150 rpm, depending on the type of extrudate. The chosen rotation speed can be chosen so that the melt is conveyed with significantly reduced or no pulsation.

A gear can be disposed between the compressor and the advantageously electrical drive, by way of which the twin screws are synchronously drivable. A reciprocal, geometrically accurate interlock of the flights is possible because of the synchronization. One screw of the twin screws is thereby advantageously not moved along by a mechanical forced coupling as in geared pumps from known examples but rather directly driven, so that high friction with the known disadvantages of high energy consumption and an inevitably associated temperature increase is avoided. This also makes it possible to operate the twin screws so that each screw rotates in opposite directions. The synchronization from the gear is furthermore advantageous in that drive forces also can be introduced directly into both twin screws, in order to achieve a better force distribution.

By way of example, the flights of both twin screws can engage with each other in such a manner that the flight gap remaining at the narrowest location forms a gap seal. This gap seal prevents the reflux of extrudate and increases the force feed and also acts as overpressure compensation. The force feed generates a high pressure buildup and, simultaneously, the pressure compensation prevents damage to the extrudate, more specifically when the gap seal is adapted to the medium to be processed. The same advantages may also apply to the housing gap.

Another advantage is that the twin screws may be driven with relatively low output, which leads to a smaller drive motor and a lesser energy consumption.

Furthermore, the number of chambers, in which the extrudate is contained, are formed between the housing and the twin screws or their flights. The chambers can be quasi closed in accordance with the gap seal and/or housing gap so that the desired pressure may be built up but that in examples with a locally excessive pressure, compensation of the pressure occurs.

Moreover, the chamber extends along the pitch of a flight. The beginning and the end of the chamber are thereby located at the intersection of the two twin screws (e.g., in the plane defined by the axes of the two twin screws), which is advantageous in that the extrudate occupies a defined place and is not mixed with another medium. At the same time, this allows for an efficient pressure build up on the perforated disc.

A housing gap can be formed between the flight and the casing, and a gap is formed between the flight and its adjacent counter-rotating twin screws, which both form a gap seal, so that the medium is substantially held in the respective chamber without a significant reflux of the medium occurring through the gaps (e.g., gap seal) into an adjacent rearward chamber. This is advantageous in that a seal is achieved between the chambers, which allow for a high pressure in each chamber and a pressure of about 400 to about 600 bar on the perforated disc and a temperature of about 100° C. to about 300° C.

The housing gap and/or the gap can have a width of about 0.05 mm to about 2 mm. The width of the gap and, thus, the size of the gap seal ultimately depend on the medium to be processed and its additives.

Twin screws are configured in such a manner that the ratio of the outer diameter relative to the core diameter is approximately 2. Depending on the type of melt (extrudate) a ratio between Da and Di having a range of about 1.6 to about 2.4 may also be chosen, thereby resulting in a large delivery volume achieved with a relatively thin and, thus, cost-effective melt pump. Having a length/diameter ratio of the counter-rotating twin screws of about 2 to about 5, such as about 3.5, the vessel may achieve a pressure of about 250 bar to about 600 bar on the perforated disc and a temperature of about 100° C. to about 350° C. This is advantageous in that the melt pump can be manufactured at low cost and utilized in a space-saving manner.

Relatively quick pressure buildup is achieved due to the cooperation of the two accurately intermeshing twin screws with the correspondingly configured flights. High pressures may be achieved, and the retention period in the vessel may be relatively small, and therefore, reducing potential thermal and mechanical damage to the extrudate.

### TPV Compositions

In some embodiments, the TPV composition can include an amount of a elastomeric polymer of about 5 wt% to about 95 wt%, such as from about 10 wt% to about 90 wt%, such as from about 20 wt% to about 85 wt%, such as from about 45 wt% to about 80 wt%, such as from about 60 wt% to about 75 wt%, based on a combined weight of the elastomeric polymer and a thermoplastic polyolefin. The elastomeric polymer, also referred to herein as “rubber,” is a dynamically-vulcanized rubber, such as an ethylene based copolymer, such as an ethylene propylene diene terpolymer.

In at least one embodiment, the amount of rubber in the TPV composition can be from about 5 wt% to about 95 wt%, such as from about 10 wt% to about 90 wt%, such as from about 20 wt% to about 85 wt%, such as from about 45 wt% to about 80 wt%, such as from about 60 wt% to about 75 wt% based on a combined weight of the rubber phase and a thermoplastic phase, including a thermoplastic polymer or a thermoplastic polyolefin, such as a propylene-based polymer, an ethylene based polymer, a butene-1-based polymer, or combinations thereof, that is from about 1.5 wt% to about 45 wt%, such as from about 10 wt% to about 40 wt%, such as from about 12 wt% to about 30 wt% based on a combined weight of the rubber phase and the thermoplastic phase.

A process for providing a homogeneous dispersion of small particle size elastomeric polymer, such as EPDM rubber, in a thermoplastic polymer, such as polypropylene, results in a locked-in morphology that provides physical properties similar to a thermoset rubber. In particular, the process provides good tensile strength and elasticity. Since TPVs are a main component of the extruded parts, such as automotive weather strips, improved processability and extrusion properties of TPVs are key to the final application use of TPVs. Improving the process further enhances factors such as processability and surface appearance.

### Rubber Phase

Rubbers that may be employed to form the rubber phase include those polymers that are capable of being cured or crosslinked by a phenolic resin or a hydrosilylation curative (e.g., silicone hydride), a peroxide with a coagent, a moisture cure via silane grafting, or an azide. The rubber phase is cross-linked after introducing the rubber to the extruder. The rubber phase can be in the form of finely-divided, particles of vulcanized or cured rubber which can be dispersed within a continuous thermoplastic phase (can also be referred to as matrix). Reference to a rubber may include mixtures of more than one rubber. Non-limiting examples of rubbers include olefinic elastomeric terpolymers, and mixtures thereof. In some embodiments, olefinic elastomeric terpolymers include ethylene based elastomers such as ethylene based copolymer rubbers and ethylene-propylene-non-conjugated diene rubbers.

### Ethylene Based Copolymer

The term ethylene based copolymer refers to rubbery terpolymers polymerized from ethylene, at least one other α-olefin monomer, and at least one diene monomer (for example, an ethylene-propylene-diene terpolymer or an EPDM terpolymer). The α-olefin monomer may include propylene, 1-butene, 1-hexene, 4-methyl-1-pentene, 1-octene, 1-decene, or combinations thereof. In at least one embodiment, the α-olefin monomer can include propylene, 1-hexene, 1-octene or combinations thereof. The diene monomers may include 5-ethylidene-2-norbornene (ENB); 5-vinyl-2-norbornene (VNB); divinylbenzene; 1,4-hexadiene; 5-methylene-2-norbornene; 1,6-octadiene; 5-methyl-1,4-hexadiene; 3,7-dimethyl-1,6-octadiene; 1,3-cyclopentadiene; 1,4-cyclohexadiene; dicyclopentadiene; or combinations thereof. Polymers prepared from ethylene, α-olefin monomer, and diene monomer may be referred to as a terpolymer or even a tetrapolymer in the event that multiple α-olefin monomers or dienes are used. An example of an ethylene based copolymer is an ethylene-propylene copolymer rubber (or ethylene-propylene copolymer).

In some embodiments, the ethylene based copolymer may have an ethylene-derived content that is from about 10 wt% to about 99.9 wt% (such as from about 10 wt% to about 90 wt%, such as from about to about , such as from about 15 wt to about , such as from about 20 wt% to about 80 wt%, such as from about 40 wt% to about 70 wt%, such as from about 50 wt% to about 70 wt%, such as from about 55 wt% to about 65 wt%, such as from about 60 wt% and about 65 wt%) based on a total weight of the ethylene-propylene rubber. In some embodiments, the ethylene-derived content is from about 40 wt% to about 85 wt%, such as from about 40 wt% to about 85 wt%, based on the total weight of the ethylene-propylene rubber.

In some embodiments, the ethylene based copolymer may have a diene-derived content that is from about 0.1 wt% to about to about 15 wt%, such as from about 0.1 wt% to about 5 wt%, such as from about 0.2 wt% to about 10 wt%, such as from about 2 wt% to about 8 wt%, or from about 4 wt% to about 12 wt%, such as from about 4 wt% to about 9 wt%) based on a total weight of the ethylene-propylene rubber. In some embodiments, the diene-derived content can be from about 3 wt% to about 15 wt% based on the total weight of the ethylene-propylene rubber.

In some embodiments, where the diene monomer includes 5-ethylidene-2-norbornene (ENB) and/or 5-vinyl-2-norbornene (VNB), the ethylene based copolymer may include at least about 0.1 wt% of diene monomer (such as at least about 1 wt%, such as at least about 3 wt%, such as at least about 4 wt%, such as at least about 5 wt%) based on a total weight of the ethylene-propylene rubber. In these and other embodiments, where the diene includes ENB or VNB, the ethylene based copolymer may include from about 1 wt% to about 15 wt% of diene monomer (such as from about 3 wt% to about 15 wt%, such as from about 4 wt% to about 12 wt%, such as from about 5 wt% to about 12 wt%, such as from about 7 wt% to about 11 wt%) based on a total weight of the ethylene-propylene rubber.

In some embodiments, the ethylene based copolymer may have an amount of oil that is from about 0 parts per hundred rubber (phr) to about 200 phr, such as from about 0 phr to about 100 phr, such as 75 phr and 100 phr.

In some embodiments, the ethylene based copolymer may have a balance of the ethylene-propylene rubber including α-olefin-derived content (e.g., C₂ to C₄₀, such as C₃ to C₂₀, such as C₃ to C₁₀ olefins, such as propylene).

In some embodiments, the ethylene based copolymer may have a weight average molecular weight (Mw) that is about 100,000 g/mol or more (such as about 200,000 g/mol or more, such as about 400,000 g/mol or more, such as about 600,000 g/mol or more). In these or other embodiments, the Mw can be about 1,200,000 g/mol or less (such as about 1,000,000 g/mol or less, such as about 900,000 g/mol or less, such as about 800,000 g/mol or less, such as from about 400,000 g/mol to about 700,000 g/mol). In these or other embodiments, the Mw can be from about 400,000 g/mol and about 3,000,000 g/mol (such as from about 400,000 g/mol to about 2,000,000, such as from about 400,000 g/mol to about 1,500,000 g/mol, such as from about 400,000 g/mol to about 1,000,000 g/mol or from about 600,000 g/mol to about 1,200,000 g/mol, such as from about 600,000 g/mol to about 1,000,000 g/mol).

In some embodiments, the ethylene based copolymer may have a number average molecular weight (Mn) that is about 20,000 g/mol or more (such as about 60,000 g/mol or more, such as about 100,000 g/mol or more, such as about 150,000 g/mol or more). In these or other embodiments, the Mn can be less than about 500,000 g/mol (such as about 400,000 g/mol or less, such as about 300,000 g/mol or less, such as about 250,000 g/mol or less).

In some embodiments, the ethylene based copolymer may have a Z-average molecular weight (Mz) that is from about 10,000 g/mol to about 7,000,000 g/mol (such as from about 50,000 g/mol to about 3,000,000 g/mol, such as from about 100,000 g/mol to about 2,000,000 g/mol, such as from about 200,000 g/mol to about 1,500,000 g/mol, such as from about 200,000 g/mol to about 1,00,000 g/mol, such as from about 200,000 g/mol to about 500,000 g/mol).

In some embodiments, the ethylene based copolymer may have a polydispersity index (Mw/Mn; PDI) that is from about 1 to about 15 (such as from about 1 to about 10, such as from about 1 to about 5, such as from about 1 to about 4, such as from about 2 to about 4 or from about 1 to about 3, such as from about 1.8 to about 3 or from about 1 to about 2, or from about 1 to about 2.5).

In some embodiments, the ethylene based copolymer may have a dry Mooney viscosity (ML₍₁₊₄₎ at 125° C.) per ASTM D1646, that is from about 10 MU to about 500 MU or from about 50 MU to about 450 MU. In these or other embodiments, the Mooney viscosity is about 50 or more, such as about 250 MU or more, such as about 350 MU or more.

In some embodiments, the ethylene based copolymer may have a g′ᵥᵢₛ that is 0.7 or more (such as about 0.75 or more, such as about 0.8 or more, 0.85 or more, such as 0.9 or more, such as 0.95 or more, for example about 0.96, about 0.97, about 0.98, about 0.99, or about 1).

In some embodiments, the ethylene-propylene rubber may have a glass transition temperature (T_{g}), as determined by Differential Scanning Calorimetry (DSC) according to ASTM E1356, that is about -20° C. or less (such as about -30° C. or less, such as about -50° C. or less). In some embodiments, T_{g} is from about -20° C. and about -60° C_{.}

In some embodiments, the ethylene based copolymer may have a large amplitude oscillatory shear (LAOS) branching index of less than about 10, such as less than about 5, such as from about -1 to about 5. In at least one embodiment, the ethylene based copolymer may have a LAOS branching index of less than about 3.

In some embodiments, the ethylene based copolymer may have a LCB index (@ 125° C. of about 2.5 or lower such as about 2.0 or lower.

In at least one embodiment, the ethylene based copolymer may have a Δδ of from about 30 degrees to 80 degrees from small amplitude oscillatory shear (SAOS), such as about 32 ° or greater, such as about 35 ° or greater. Δδ is the difference between the phase angle (δ) at frequencies of 0.1 and 128 rad/s, as derived from a frequency sweep at 125° C., i.e., where Δδ(125° C.)=δ(0.1 rad/s)-δ(128 rad/s).

The ethylene based copolymer may be manufactured or synthesized by using a variety of techniques. For example, these terpolymers can be synthesized by employing solution, slurry, or gas phase polymerization techniques or combination(s) thereof that employ various catalyst systems including Ziegler-Natta systems including vanadium catalysts and take place in various phases such as solution, slurry, or gas phase. Exemplary catalysts include single-site catalysts including constrained geometry catalysts involving Group IV-VI metallocenes. In some embodiments, the EPDMs can be produced via a conventional Zeigler-Natta catalysts using a slurry process, especially those including Vanadium compounds, as disclosed in U.S. Pat. No. 5,783,645, as well as metallocene catalysts, which are also disclosed in U.S. Pat. No. 5,756,416. Other catalyst systems such as the Brookhart catalyst system may also be employed. Optionally, such EPDMs can be prepared using the above catalyst systems in a solution process.

In some embodiments, the rubber can be highly cured. In some embodiments, the rubber is advantageously partially or fully (completely) cured. The degree of cure can be measured by determining the amount of rubber that is extractable from the TPV composition by using cyclohexane or boiling xylene as an extractant. This method is disclosed in U.S. Pat. No. 4,311,628, which is incorporated herein by reference for purpose of U.S. patent practice. In some embodiments, the rubber has a degree of cure where not more than about 5.9 wt%, such as not more than about 5 wt%, such as not more than about 4 wt%, such as not more than about 3 wt% is extractable by cyclohexane at 23° C. as described in U.S. Pat. Nos. 5,100,947 and 5,157,081, which are incorporated herein by reference for purpose of U.S. patent practice. In these or other embodiments, the rubber is cured to an extent where greater than about 94 wt%, such as greater than about 95 wt%, such as greater than about 96 wt%, such as greater than about 97 wt% by weight of the rubber is insoluble in cyclohexane at 23° C. Alternately, in some embodiments, the rubber has a degree of cure such that the crosslink density is at least 4×10⁻⁵ moles per milliliter of rubber, such as at least 7×10⁻⁵ moles per milliliter of rubber, such as at least 10×10⁻⁵ moles per milliliter of rubber. See also “Crosslink Densities and Phase Morphologies in Dynamically Vulcanized TPEs,” by Ellul et al., RUBBER CHEMISTRY AND TECHNOLOGY, Vol. 68, pp. 573-584 (1995).

Despite the fact that the rubber may be partially or fully cured, the TPV compositions of this disclosure can be processed and reprocessed by conventional plastic processing techniques such as extrusion, injection molding, blow molding, and/or compression molding to form an article. The rubber within these thermoplastic elastomers can be in the form of finely-divided and well-dispersed particles of vulcanized or cured rubber within a continuous thermoplastic phase. In some embodiments, a co-continuous morphology or a phase inversion can be achieved. In those embodiments where the cured rubber is in the form of finely-divided and well-dispersed particles within the thermoplastic medium, the rubber particles can have an average diameter that is about 50 µm or less (such as about 30 µm or less, such as about 10 µm or less, such as about 5 µm or less, such as about 1 µm or less). In some embodiments, at least about 50%, such as about 60%, such as about 75% of the particles have an average diameter of about 5 µm or less, such as about 2 µm or less, such as about 1 µm or less.

Some elastomeric terpolymers are commercially available under the tradenames Vistalon™ (ExxonMobil Chemical Co.; Houston, Tex.), Keltan™ (Arlanxeo Performance Elastomers; Orange, TX.), Nordel™ IP (Dow), NORDEL MG™ (Dow), Royalene™ (Lion Elastomers), and Suprene™ (SK Global Chemical). Specific examples include Vistalon™ 3666, EXP-Vistalon (made according to WO2017127184A1), Keltan™ 5469 Q, Keltan™ 4969 Q, Keltan™ 5469 C, Keltan™ 4869 C, Royalene™ 694, Royalene™ 677, Suprene™ 512F, Nordel™ 6555, Keltan 5467C, and Nordel™ 4555OE.

In some embodiments, the ethylene propylene rubber may be obtained in an oil extended form, with about a 50 phr to about 200 phr process oil, such as about 75 phr to about 120 phr process oil on the basis of 100 phr of ethylene propylene rubber.

### Thermoplastic Phase

In some embodiments, the thermoplastic phase of the TPV composition includes a polymer that can flow above its melting temperature. In some embodiments, the major component of the thermoplastic phase includes at least one thermoplastic polyolefin such as a polypropylene (such as a homopolymer, random copolymer, or impact copolymer, or combination thereof), an ethylene based polymer (e.g., a polyethylene), or a butene-based polymer (e.g., polybutene). In some embodiments, the thermoplastic phase may also include, as a minor constituent, at least one thermoplastic polyolefin such as an ethylene based polymer (e.g., a polyethylene), a propylene-based polymer (e.g., a polypropylene), or a butene-based polymer (e.g., a polybutene).

### 1. Propylene-Based Polymer

Propylene-based polymers include those solid, generally high molecular weight plastic resins that primarily include units deriving from the polymerization of propylene. In some embodiments, at least 75%, in other embodiments at least 90%, in other embodiments at least 95%, and in other embodiments at least 97% of the units of the propylene-based polymer derive from the polymerization of propylene. In some embodiments, these polymers include homopolymers of propylene. Homopolymer polypropylene can include linear chains and/or chains with long chain branching.

In some embodiments, the propylene-based polymers may also include units deriving from the polymerization of ethylene and/or α-olefins such as 1-butene, 1-hexene, 1-octene, 2-methyl-1-propene, 3-methyl-1-pentene, 4-methyl-1-pentene, 5-methyl-1-hexene, and mixtures thereof. Specifically included are the reactor, impact, and random copolymers of propylene with ethylene or the higher α-olefins, described above, or with C₁₀-C₂₀ olefins.

In some embodiments, the propylene-based polymer includes semi-crystalline polymers. In some embodiments, these polymers may be characterized by a crystallinity of at least 25 wt% or more (such as about 55 wt% or more, such as about 65 wt% or more, such as about 70 wt% or more). Crystallinity may be determined by dividing the heat of fusion (Hf) of a sample by the heat of fusion of a 100% crystalline polymer, which is assumed to be 209 joules/gram for polypropylene.

In some embodiments, the propylene-based polymer may have an Hf of about 52.3 J/g or more (such as about 100 J/g or more, such as about 125 J/g or more, such as about 140 J/g or more).

In some embodiments, the propylene-based polymer may have a weight average molecular weight (Mw) of from about 50,000 g/mol to about 2,000,000 g/mol (such as from about 100,000 g/mol to about 1,000,000 g/mol, such as from about 100,000 g/mol to about 600,000 g/mol or from about 400,000 g/mol to about 800,000 g/mol) as measured by GPC with polystyrene standards.

In some embodiments, the propylene-based polymer may have a number average molecular weight (Mn) of from about 25,000 g/mol to about 1,000,000 g/mol (such as from about 50,000 g/mol to about 300,000 g/mol) as measured by GPC with polystyrene standards.

In some embodiments, the propylene-based polymer may have a g′ᵥᵢₛ of about 1 or less (such as 0.9 or less, such as 0.8 or less, such as 0.6 or less, such as 0.5 or less). In some embodiments, the polypropylene may have a g′ᵥᵢₛ that is greater than about 0.90, such as greater than about 0.97. In some embodiments, the polypropylene has a g′ᵥᵢₛ that is from about 0.7 to about 0.88.

In some embodiments, the propylene-based polymer may have a melt mass flow rate (MFR) (ASTM D1238, 2.16 kg weight @ 230° C.) of about 0.1 g/10 min or more (such as about 0.2 g/10 min or more, such as about 0.2 g/10 min or more). Alternately, the MFR may be from about 0.1 g/10 min to about 50 g/10 min, such as from about 0.5 g/10 min to about 5 g/10 min, such as from about 0.5 g/10 min to about 3 g/10 min.

In some embodiments, the propylene-based polymer may have a melt temperature (Tₘ) of from about 110° C. to about 170° C. (such as from about 140° C. to about 168° C., such as from about 160° C. to about 165° C.).

In some embodiments, the propylene-based polymer may have a glass transition temperature (T_{g}) of from about -50° C. to about 10° C. (such as from about -30° C. to about 5° C., such as from about -20° C. to about 2° C.).

In some embodiments, the propylene-based polymer has a crystallization temperature (T_{c}) that can be about 75° C. or more (such as about 95° C. or more, such as about 100° C. or more, such as about 105° C. or more (such as from about 105° C. to about 130° C.).

In some embodiments, the propylene-based polymers can include a homopolymer of a high-crystallinity isotactic or syndiotactic polypropylene. This polypropylene can have a density of from about 0.89 to about 0.91 g/ml, with the largely isotactic polypropylene having a density of from about 0.90 to about 0.91 g/ml. Also, high and ultra-high molecular weight polypropylene that has a fractional melt flow rate can be employed. In some embodiments, polypropylene resins may be characterized by a MFR (ASTM D-1238; 2.16 kg @ 230° C.) that is about 10 dg/min or less (such as about 1.0 dg/min or less, such as about 0.5 dg/min or less).

In some embodiments, the polypropylene can include a homopolymer, random copolymer, or impact copolymer polypropylene or combination thereof. In some embodiments, the polypropylene is a high melt strength (HMS) long chain branched (LCB) homopolymer polypropylene.

The propylene-based polymers may be synthesized by using an appropriate polymerization technique known in the art such as the conventional Ziegler-Natta type polymerizations, and catalysis employing single-site organometallic catalysts including metallocene catalysts.

Examples of polypropylene useful for the TPV compositions described herein include ExxonMobil™ PP5341 (available from ExxonMobil); Achieve™ PP6282NE1 (available from ExxonMobil) and/or polypropylene resins with broad molecular weight distribution as described in US 9,453,093 and US 9,464,178; and other polypropylene resins described in US20180016414 and US20180051160 (for example, EXP-PP, as shown in the Table below); Waymax™ MFX6 (available from Japan Polypropylene Corp.); Borealis Daploy™ WB140 (available from Borealis AG); and Braskem Ampleo 1025MA and Braskem Ampleo 1020GA (available from Braskem Ampleo). Table 5 shows the characteristics of selected propylene based polymers. g′ᵥᵢₛ can be measured using GPC-4D. Techniques for determining the molecular properties are described below.

TABLE 5

| Grade | Mw (g/mol) | Mw/Mn | LCB-g′vis |
|---|---|---|---|
| ExxonMobil™ PP5341 | 562,000 | 7.5 | 1.000 |
| EXP-PP | 540,000 | 16 | 0.857 |

g′ᵥᵢₛ is measured using GPC-4D.

### 2. Ethylene Based Polymer

Ethylene based polymers include those solid, generally high-molecular weight plastic resins that primarily include units deriving from the polymerization of ethylene. In some embodiments, at least 90%, in other embodiments at least 95%, and in other embodiments at least 99% of the units of the ethylene based polymer can derive from the polymerization of ethylene. In particular embodiments, these polymers include homopolymers of ethylene.

In some embodiments, the ethylene based polymers may also include units deriving from the polymerization of α-olefin comonomer such as propylene, 1-butene, 1-hexene, 1-octene, 2-methyl-1-propene, 3-methyl-1-pentene, 4-methyl-1-pentene, 5-methyl-1-hexene, and mixtures thereof.

In some embodiments, the ethylene based polymer may have a melt index (MI) (ASTM D1238, 2.16 kg@190° C.) of from about 0.1 dg/min to about 1,000 dg/min (such as from about 1.0 dg/min to about 200 dg/min, such as from about 7.0 dg/min to about 20.0 dg/min).

In some embodiments, the ethylene based polymer may have a melt temperature (Tₘ) of from about 140° C. to about 90° C. (such as from about 135° C. to about 125° C., such as from about 130° C. to about 120° C.), as measured by Differential Scanning Calorimetry (DSC) at 10° C./min.

The ethylene based polymers may be synthesized by using an appropriate polymerization technique known in the art such as the conventional Ziegler-Natta type polymerizations, and catalysis employing single-site organometallic catalysts including metallocene catalysts. Some ethylene based polymers are commercially available. For example, polyethylene is commercially available under the tradename ExxonMobil™ Polyethylene (ExxonMobil). ethylene based copolymers are commercially available under the tradename ExxonMobil™ Polyethylene (ExxonMobil), which include metallocene produced linear low density polyethylene including Exceed™, Enable™, and Exceed™ XP.

In some embodiments, the ethylene based polymer can include a low density polyethylene, a linear low density polyethylene, or a high density polyethylene. In some embodiments, the ethylene based polymer can be a high melt strength (HMS) long chain branched (LCB) homopolymer polyethylene.

Other ethylene based polymers that can be used include Hostalen (LBI), Paxxon (ExxonMobil) and Escorene (ExxonMobil).

### 3. 1-Butene-Based Polymer

Butene-1-based polymers include those solid, generally high-molecular weight isotactic butene-1 resins that primarily include units deriving from a polymerization of 1-butene.

In some embodiments, the 1-butene-based polymers can include isotactic poly(butene-1) homopolymers. In some embodiments, the 1-butene-based polymers may also include units deriving from the polymerization of an α-olefin comonomer such as ethylene, propylene, 1-butene, 1-hexane, 1-octene, 4-methyl-1-pentene, 2-methyl-1-propene, 3-methyl-1-pentene, 4-methyl-1-pentene, 5-methyl-hexene, and mixtures of two or more thereof.

In some embodiments, the 1-butene-based polymer includes one or more of the following characteristics:

In some embodiments, the 1-butene-based polymer can have at least 90 wt% or more of the units of the 1-butene-based polymer derive from the polymerization of 1-butene (such as about 95 wt% or more, such as about 98 wt% or more, such as about 99 wt% or more). In some embodiments, these polymers can include homopolymers of 1-butene.

In some embodiments, the 1-butene-based polymer can have a melt index (MI) (ASTM D1238, 2.16 kg @ 190° C.) that can be about 0.1 dg/min to 800 dg/min (such as from about 0.3 dg/min to about 200 dg/min, such as from about 0.3 dg/min to about 4.0 dg/min). In these or other embodiments, a MI can be about 500 dg/min or less (such as about 100 dg/min or less, such as about 10 dg/min or less, such as about 5 dg/min or less).

In some embodiments, the 1-butene-based polymer can have a melt temperature (Tₘ) that can be from about 130° C. to about 110° C. (such as from about 125° C. to about 115° C., such as from about 125° C. to about 120° C.), as measured by DSC at 10° C./min.

In some embodiments, the 1-butene-based polymer can have a density, as determined according to ASTM D792, that can be from about 0.897 g/ml to about 0.920 g/ml, such as from about 0.910 g/ml to about 0.920 g/ml. In these or other embodiments, a density that can be about 0.910 g/ml or more, such as 0.915 g/ml or more, such as about 0.917 g/ml or more.

The 1-butene-based polymers may be synthesized by using an appropriate polymerization technique known in the art such as the conventional Ziegler-Natta type polymerizations, and catalysis employing single-site organometallic catalysts including metallocene catalysts. Some 1-butene-based polymers are commercially available. For example, isotactic poly(1-butene) is commercially available under the tradename Polybutene Resins or PB (Basell).

### Curative

In some embodiments, the rubber is cured or crosslinked by dynamic vulcanization. The term dynamic vulcanization refers to a vulcanization or curing process for a rubber contained in a blend with a thermoplastic resin, wherein the rubber is crosslinked or vulcanized under conditions of high shear at a temperature above the melting point of the thermoplastic. The rubber can be cured by employing a variety of curative systems that include curatives. Exemplary curatives include phenolic resin cure systems, peroxide cure systems, silicon-based cure systems (such as hydrosilylation and silane grafting followed by moisture cure), sulfur-based cure systems, or combinations thereof.

Dynamic vulcanization can occur in the presence of the thermoplastic polyolefin which can be added after dynamic vulcanization (e.g., post added), or both (e.g., some polyolefin can be added prior to dynamic vulcanization and some polyolefin can be added after dynamic vulcanization).

Useful phenolic cure systems are disclosed in U.S. Pat. Nos. 2,972,600, 3,287,440, 5,952,425 and 6,437,030.

In some embodiments, phenolic resin curatives include resole resins, which can be made by the condensation of alkyl substituted phenols or unsubstituted phenols with aldehydes, such as formaldehydes, in an alkaline medium or by condensation of bi-functional phenoldialcohols. The alkyl substituents of the alkyl substituted phenols may have from about 1 carbon atom to about 10 carbon atoms, such as dimethylolphenols or phenolic resins, substituted in para-positions with alkyl groups having from about 1 carbon atom to about 10 carbon atoms. In some embodiments, a blend of octylphenol-formaldehyde and nonylphenol-formaldehyde resins is employed. The blend includes from about 25 wt% to about 40 wt% octylphenol-formaldehyde and from about 75 wt% to about 60 wt% nonylphenol-formaldehyde, such as from about 30 wt% to about 35 wt% octylphenol-formaldehyde and from about 70 wt% to about 65 wt% nonylphenol-formaldehyde. In some embodiments, the blend includes about 33 wt% octylphenol-formaldehyde and about 67 wt% nonylphenol-formaldehyde resin, where each of the octylphenol-formaldehyde and nonylphenol-formaldehyde include methylol groups. This blend can be solubilized in paraffinic oil at about 30% solids without phase separation.

Useful phenolic resins may be obtained under the tradenames SP-1044, SP-1045 (Schenectady International; Schenectady, N.Y.), which may be referred to as alkylphenolformaldehyde resins.

An example of a phenolic resin curative includes that defined according to the general formula

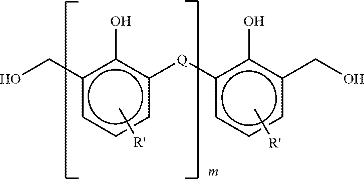

where Q is a divalent radical selected from the group consisting of —CH₂—, —CH₂—O—CH₂—; m is zero or a positive integer from 1 to 20 and R′ is an organic group. In some embodiments, Q is the divalent radical —CH₂—O—CH₂—, m is zero or a positive integer from 1 to 10, and R′ is an organic group having less than 20 carbon atoms. In other embodiments, m is zero or a positive integer from 1 to 10 and R′ is an organic radical having from 4 to 12 carbon atoms.

In some embodiments, the phenolic resin is used in combination with a halogen source, such as stannous chloride, and metal oxide or reducing compound such as zinc oxide.

### Other Constituents

Other constituents can be added in one or more locations along the extruder and/or in the feed throat. In some embodiments, the TPV composition may include a polymeric processing additive. The processing additive may be a polymeric resin that has a very high melt flow index. These polymeric resins include both linear and branched polymers that have a melt flow rate that is about 500 dg/min or more, such as about 750 dg/min or more, such as about 1000 dg/min or more, such as about 1200 dg/min or more, such as about 1500 dg/min or more. Mixtures of various branched or various linear polymeric processing additives, as well as mixtures of both linear and branched polymeric processing additives, can be employed. Reference to polymeric processing additives can include both linear and branched additives unless otherwise specified. Linear polymeric processing additives include polypropylene homopolymers, and branched polymeric processing additives include diene-modified polypropylene polymers. TPV compositions that include similar processing additives are disclosed in U.S. Pat. No. 6,451,915, which is incorporated herein by reference for purpose of U.S. patent practice.

In some embodiments, the TPV compositions of the present disclosure may optionally include reinforcing and non-reinforcing fillers, compatibilizers, antioxidants, stabilizers, rubber processing oil, lubricants, antiblocking agents, anti-static agents, waxes, foaming agents, pigments, flame retardants, nucleating agents, and other processing aids known in the rubber compounding art. These additives can be used in the TPV compositions at an amount up to about 50 wt% of the total weight of the TPV composition.

Fillers and extenders that can be utilized include conventional inorganics such as calcium carbonate, clays, silica, talc, titanium dioxide, carbon black, a nucleating agent, mica, wood flour, and the like, and blends thereof, as well as inorganic and organic nanoscopic fillers.

In some embodiments, the TPV compositions may include a plasticizer such as an oil, such as a mineral oil, a synthetic oil, an ester plasticizer, or combinations thereof. These oils may also be referred to as plasticizers or extenders. Mineral oils may include aromatic oils, naphthenic oils, paraffinic oils, isoparaffinic oils, synthetic oils, and combinations thereof. In some embodiments, the mineral oils may be treated or untreated. Useful mineral oils can be obtained under the tradename SUNPAR™ (Sun Chemicals). Other oils are available under the tradename PARALUX™ (Chevron), and PARAMOUNT™ (Chevron) such as Paramount™ 6001R (Chevron Phillips). Other oils that may be used include hydrocarbon oils and plasticizers, such as organic esters and synthetic plasticizers. Many additive oils are derived from petroleum fractions, and have particular ASTM designations depending on whether they fall into the class of paraffinic, naphthenic, or aromatic oils. Other types of additive oils include alpha olefinic synthetic oils, such as liquid polybutylene. Additive oils other than petroleum based oils can also be used, such as oils derived from coal tar and pine tar, as well as synthetic oils, e.g., polyolefin materials.

Examples of oils include base stocks. According to the American Petroleum Institute (API) classifications, base stocks are categorized in five groups based on their saturated hydrocarbon content, sulfur level, and viscosity index (Table 6). Lube base stocks are typically produced in large scale from non-renewable petroleum sources. Group I, II, and III base stocks are all derived from crude oil via extensive processing, such as solvent extraction, solvent or catalytic dewaxing, and hydroisomerization, hydrocracking and isodewaxing, isodewaxing and hydrofinishing. See “New Lubes Plants Use State-of-the-Art Hydrodewaxing Technology” in Oil & Gas Journal, Sep. 1, 1997; Krishna et al., “Next Generation Isodewaxing and Hydrofinishing Technology for Production of High Quality Base Oils”, 2002 NPRA Lubricants and Waxes Meeting, November 14-15, 2002; Gedeon and Yenni, “Use of “Clean” Paraffinic Processing Oils to Improve TPE Properties”, Presented at TPEs 2000 Philadelphia, P A., September 27-28, 1999.

Group III base stocks can also be produced from synthetic hydrocarbon liquids obtained from natural gas, coal or other fossil resources, Group IV base stocks are polyalphaolefins (PAOs), and are produced by oligomerization of alpha olefins, such as 1-decene. Group V base stocks include all base stocks that do not belong to Groups I-IV, such as naphthenics, polyalkylene glycols (PAG), and esters.

TABLE 6

| API Classification | Group I | Group II | Group III | Group IV | Group V |
|---|---|---|---|---|---|
| % Saturates | <90 | ≧90 | ≧90 | Polyalphaolefins (PAOs) | All others not belonging to Groups I-IV |
| % S | >0.03 | ≦0.03 | ≦0.03 | | |
| Viscosity Index (VI) | 80-120 | 80-120 | ≧120 | | |

In some embodiments, the Group II base stocks include, based on the total weight of the base stock, a total amount of aromatic compounds and polar compounds of greater than about 4.5 wt% or less than about 4.5 wt%, as measured according to ASTM 2007, and/or the viscosity of the oil is at least about 80 cSt at 40° C.

In some embodiments the mineral oil can have a viscosity of at least 10 cSt at 100° C.

In some embodiments the oil may include, based on the total weight of the oil, less than about 4 wt% of aromatic compounds and/or less than about 0.3 wt% of polar compounds, as measured according to ASTM 2007.

In some embodiments, synthetic oils include polymers and oligomers of butenes. For example, a synthetic oil can be an oligomer of 1-butene. In some embodiments, the oligomeric forms of synthetic oils can be characterized by a number average molecular weight (Mn) of from about 300 g/mol to about 9,000 g/mol, and in other embodiments from about 700 g/mol to about 1,300 g/mol. In some embodiments, these oligomers include isobutenyl mer units. Exemplary synthetic oils include polyisobutylene, poly(isobutylene-co-butene), and mixtures thereof. In some embodiments, synthetic oils may include polylinear α-olefins, poly-branched α-olefins, hydrogenated polyalphaolefins, and mixtures thereof.

In some embodiments, the synthetic oils include synthetic polymers or copolymers having a viscosity of about 20 cps or more, such as about 100 cps or more, such as about 190 cps or more, where the viscosity is measured by a Brookfield viscometer according to ASTM D-4402 at 38° C. In these or other embodiments, the viscosity of these oils can be about 4,000 cps or less, such as about 1,000 cps or less.

In some embodiments, the oil has a DMSO extract of less than 3 wt% measured according to IP-346.

Useful synthetic oils can be commercially obtained under the tradenames Polybutene™ (Soltex; Houston, Tex.), and Indopol™ (Ineos). White synthetic oil is available under the tradename SPECTRASYN™ (ExxonMobil), formerly SHF Fluids (Mobil), Elevast™ (ExxonMobil), and white oil produced from gas to liquid technology such as Risella™ X 415/420/430 (Shell) or Primol™ (Exxonmobil) series of white oils, e.g. Primol™ 352, Primol™ 382, Primol™ 542, or Marcol™ 82, Marcol™ 52, Drakeol™ (Pencero) series of white oils, e.g. Drakeol™ 34 or combinations thereof. Oils described in U.S. Pat. No. 5,936,028 may also be employed.

Overall, the present disclosure provides extrusion methods and extruder systems capable of providing TPV composition having enhanced processability and enhanced surface properties using less fillers. Extruder systems and processes of the present disclosure can introduce thermoplastic polymer separately from rubber to provide the TPV compositions.

The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of the present disclosure, additionally, they do not exclude impurities and variances normally associated with the elements and materials used.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

All numerical values within the detailed description herein are modified by “about” the indicated value, and take into account experimental error and variations that would be expected by a person having ordinary skill in the art.

All documents described herein are incorporated by reference herein, including any priority documents and or testing procedures to the extent they are not inconsistent with this text. As is apparent from the foregoing general description and the specific embodiments, while forms of the present disclosure have been illustrated and described, various modifications can be made without departing from the spirit and scope of the present disclosure. Accordingly, it is not intended that the present disclosure be limited thereby. Likewise, the term “comprising” is considered synonymous with the term “including” for purposes of United States law. Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

While the present disclosure has been described with respect to a number of embodiments and examples, those skilled in the art, having benefit of this disclosure, will appreciate that other embodiments can be devised which do not depart from the scope and spirit of the present disclosure.

1. A method of forming a thermoplastic vulcanizate (TPV) composition, the method comprising:
introducing a thermoplastic polymer to an extruder through a feed throat;
introducing an elastomeric polymer to a melt feeder and forming an elastomeric polymer melt comprising the elastomeric polymer, the melt feeder coupled to the extruder;
introducing the elastomeric polymer melt from the melt feeder to the extruder, wherein the thermoplastic polymer and the elastomeric polymer melt are fed separately to the extruder; and
mixing the thermoplastic polymer and the elastomeric polymer melt in the extruder with a plurality of intermeshing screws, wherein the extruder comprises a plurality of mixing sections.

2. The method of claim 1, wherein the plurality of mixing sections comprises at least three mixing sections, wherein at least one of the mixing sections has a mixing intensity that is greater relative to another mixing section of the at least three mixing sections.

3. The method of claim 2, wherein a second mixing section has a mixing intensity that is greater relative to a mixing intensity of each of a first mixing section upstream of the second mixing section, and a third mixing section downstream of the second mixing section, of the at least three mixing sections.

4. The method of claim 1, wherein a mixing intensity of a mixing section located at an initial ½ to ¾ length of the extruder is greater than a mixing intensity of mixing sections along other lengths of the extruder.

5. The method of claim 1, wherein the thermoplastic polymer and the elastomeric polymer melt is performed by:
operating a first section of the plurality of mixing sections at a dynamic mixing intensity of about 1000 sec⁻¹ to about 1800 sec⁻¹;
operating a second section of the plurality of mixing sections at a dynamic mixing intensity of about 1200 sec⁻¹ to about 2100 sec⁻¹;
operating a third section of the plurality of mixing sections at a dynamic mixing intensity of about 3100 sec⁻¹ to about 5600 sec⁻¹; and
operating a fourth section of the plurality of mixing sections at a dynamic mixing intensity of about 1,100 sec⁻¹ to about 1,900 sec⁻¹, wherein each of the first, second, third and fourth sections are in sequence with one another from an upstream end to a downstream end of the extruder.

6. The method of claim 1, wherein mixing the thermoplastic polymer and the elastomeric polymer melt is performed by:
operating a first section of the plurality of mixing sections with an effective mixing intensity of about 80 to about 160;
operating a second section of the plurality of mixing sections with an effective mixing intensity of about 110 to about 190;
operating a third section of the plurality of mixing sections with an effective mixing intensity of about 290 to about 450; and
operating a fourth section of the plurality of mixing sections with an effective mixing intensity of about 90 to about 170, wherein each of the first, second, third and fourth sections are in sequence with one another from an upstream end to a downstream end of the extruder.

7. The method of claim 1, wherein the thermoplastic polymer is introduced at a first location and the elastomeric polymer melt is introduced at a second location, the second location is downstream of the first location, and the first and second location are each located at an initial 1/16 to ¼ length of the extruder.

8. The method of claim 1, further comprising introducing a curative to the extruder at a third location of the extruder, the third location located downstream of the first and second location, the third location located at an initial ⅓ to ⅔ length of the extruder.

9. The method of claim 1, further comprising introducing a powder blend comprising a curing moderator and a filler to the extruder through the feed throat.

10. The method of claim 9, wherein the filler comprises a material selected from the group consisting of calcium carbonate, clays, silica, talc, titanium dioxide, carbon black, a nucleating agent, mica, wood flour, inorganic nanoscopic fillers, organic nanoscopic fillers, and combinations thereof.

11. The method of claim 9, wherein the curing moderator comprises a phenolic resin.

12. The method of claim 1, wherein the thermoplastic polymer is selected from the group consisting of polypropylene homopolymer, polyethylene homopolymer, propylene ethylene copolymer, and combinations thereof.

13. The method of claim 1, wherein the elastomeric polymer comprises an ethylene propylene diene terpolymer.

14. The method of claim 1, further comprising injecting process oil at one or more locations along the extruder.

15. The method of claim 14, wherein:
the process oil is a paraffinic oil,
the process oil is injected through one or more liquid pumps coupled to the extruder, and
the process oil is injected upstream of a curative introduced to the extruder, downstream of the curative, or upstream and downstream of the curative.

16. The method of claim 1, wherein forming the elastomeric polymer melt in the melt feeder is performed at a temperature of about 90° C. to about 120° C.

17. The method of claim 1, further comprising introducing a powder blend comprising a curing moderator and a filler to the feed throat, wherein the powder blend is introduced in an amount of about 1 part per hundred rubber (phr) to about 4 phr.

18. The method of claim 17, wherein the curing moderator is introduced to the feed throat in an amount of about 0.5 phr to about 2.0 phr.

19. The method of claim 18, wherein the curing moderator is selected from the group consisting of stannous chloride, zinc oxide, and a combination thereof.

20. The method of claim 1, wherein the thermoplastic polymer is introduced in an amount of about 7 phr to about 100 phr to the feed throat.

21. The method of claim 1, wherein the process oil is introduced in an amount of about 25 phr to about 41 phr.

22. The method of claim 1, wherein the curative is introduced in an amount of about 3 phr to about 10 phr.

23. The method of claim 1, further comprising providing an extrudate formed from the thermoplastic polymer and the elastomeric polymer melt from the extruder to a twin screw melt pump to form a composition and removing the composition from the twin screw melt pump.

24. The method of claim 1, wherein mixing the thermoplastic polymer and the elastomeric polymer melt in the extruder is performed with a total effective mixing intensity of about 690 to about 830.

25. The method of claim 1, wherein mixing the thermoplastic polymer and the elastomeric polymer melt in the extruder is performed with a total dynamic mixing intensity of about 7,000 sec⁻¹ to about 12,000 sec-¹.

26. The method of claim 1, wherein mixing the thermoplastic polymer and the elastomeric polymer melt in the extruder is performed at an average extruder temperature of about 160° C. to about 320° C.

27. The method of claim 1, wherein the TPV composition has an extrusion surface roughness (ESR) of about 25 µin to about 50 µin.

28. The method of claim 1, wherein the TPV composition has a head pressure drop of about 40% or less relative to a control composition made from introducing the thermoplastic polymer and elastomeric polymer simultaneously to the extruder.

29. The method of claim 1, wherein the TPV composition comprises about 23 or less surface spots using visual observation of three strips.

30. An extruder system, comprising:
an extruder having a first end, a second end, and a plurality of ports disposed along the extruder;
a feed throat coupled to a first port, of the plurality of ports, at the first end of the extruder;
a melt feeder coupled to a second port, of the plurality of ports, downstream of the first port;
a curative source coupled to a third port, of the plurality of ports, the third port disposed downstream or upstream of the second port; and
a melt pump coupled to the second end of the extruder.

31. The extruder system of claim 30, wherein a process oil pump is coupled to a fourth port, of the plurality of ports, upstream or downstream of the third port.

32. A method of forming a thermoplastic vulcanizate (TPV) composition, the method comprising:
introducing a thermoplastic polymer to an extruder though a feed throat at a first location;
introducing an elastomeric polymer to a melt feeder and forming an elastomeric polymer melt comprising the elastomeric polymer, the melt feeder coupled to the extruder;
introducing the elastomeric polymer melt from the melt feeder to the extruder at a second location downstream of the first location; and
mixing the thermoplastic polymer and the elastomeric polymer melt in the extruder with a plurality of intermeshing screws.

33. (canceled)

34. (canceled)
